(19) United States
(12) Patent Application Publication
(10) Pub. No.: US 2009/0327454 A1
(43) Pub. Date: Dec. 31, 2009

(54) SERVICE FLOW PROCESSING APPARATUS AND METHOD

(75) Inventor: Shingo Iwasaki, Fujisawa-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/473,654

(22) Filed: May 28, 2009

(30) Foreign Application Priority Data
Jun. 30, 2008 (JP) 2008-171233

(51) Int. Cl. G06F 15/173; G06F 15/16

(52) U.S. Cl. 709/219

(57) ABSTRACT

A service flow processing apparatus requests a service on a network to perform processing in accordance with a service flow description document and an interface description document, and receives a response from the service. The service flow processing apparatus also generates a proxy service that corresponds to the service, and if a normal response has not been received from the service, the service flow processing apparatus changes the destination of the request for the service described in the interface description document to the proxy service.

### BACKGROUND OF THE INVENTION

1. Field of the Invention

The present invention relates to a service flow processing apparatus that requests a service on a network to perform a process in accordance with a service flow description document and an interface description document and receives a response from the service, and a service flow processing method.

2. Description of the Related Art

Heretofore, techniques are known for sequentially executing Web services in accordance with a Web service flow description document (structured document) for sequentially executing Web services (e.g., see “Business Process with BPEL4WS: Understanding BPEL4WS, Part 1” found at http://www.ibm.com/developerworks/jp/webservices/librar y/ws-bpelcol1/). WS-BPEL (Web Service Business Process Execution Language) is widely used as this structured document. WS-BPEL is a Web service flow description language described in XML (eXtensible Markup Language). The WS-BPEL specification is administered by OASIS (Organization for the Advancement of Structured Information Standards).

Note that with WS-BPEL, WSDL (Web Services Description Language) is used as an interface for identifying Web services. WSDL is a language used for describing a Web service interface, and the WSDL specification is published by the World Wide Web Consortium (W3C). Details of the WSDL specification can be found at http://www.w3.org/TR/wsdl.

A flow processing apparatus reads a Web service flow description document and sequentially executes Web services in accordance with the content described therein, and such a flow processing apparatus invokes a Web service in the following flow in accordance with the content of the Web service flow description.

Firstly, a Web service interface description document (WSDL) for the Web service to be invoked is read. A schema language (XML Schema), which is a structure definition described in WSDL, is then referenced in order to find out the type of message that the target Web service is able to receive. The XML Schema is defined by the W3C. The framework of a SOAP (Simple Object Access Protocol) message in XML format is generated by using the referenced schema. SOAP is defined by the W3C.

Next, data to be transmitted is inserted into the generated SOAP message framework using an XPath (XML Path Language) to complete the SOAP message, and the SOAP message is transmitted. XPath is defined by the W3C. A response transmitted from the Web service as a result of being invoked is received as a SOAP message.

Next, processing such as extracting data from the received SOAP message or manipulating the message is performed. The processing result is then generated as a SOAP message using the above method and transmitted to the next Web service.

Also, in order to handle a case in which an external Web service has stopped, there has been a proposal to manage the state of the external Web service, thus reducing the load on a service requester that accesses the external Web service. For example, see Japanese Patent Laid-Open No. 2004-185138.

However, when accessing an external Web service with the conventional flow processing apparatus, flow processing stops if the device publishing the external Web service is cut off from the power supply or the external Web service has been stopped. Consequently, in such a case, there is the problem that it is difficult to proceed to the next planned flow process described in the service flow description document.

In such a case, it is possible to envision various abnormal states in advance and describe avoidance processing content in the service flow description document so as to prevent the flow processing from stopping. However, in order to handle various abnormal states, the service flow description document itself becomes complex, there is a rise in the human time and effort required to create the service flow description document, and the human cost increases.

Also, in order to handle various abnormal states, the size of the service flow description document itself becomes massive, and therefore when the service flow description document is read to a low-resource device, it is possible for the processing capability of the resources in the device to be exceeded. Consequently, processing becomes impossible from that point, and there is the problem that it is difficult to continue the processing described in the service flow description document.

There has also been proposed a method in which a service broker that manages the states of external Web services is provided, and access to the external Web services is necessarily performed via the service broker. However, if an external Web service stops due an unanticipated problem in a state in which the external Web service has not sent a stop announcement to the service broker, the service requester will be unable to access the external Web service, and processing will stop.

Also, since access to an external Web service is necessarily performed via the service broker even if the external Web service is not stopped, the time required to invoke the external Web service, cause processing to be performed, and receive a processing result can be assumed to be longer than the case of making a direct connection.

Also, if a problem occurs in the service broker itself, an external Web service cannot be accessed even if it has not stopped.

Furthermore, since the service broker generates a proxy for each external Web service, and the generated proxies continue to exist even if an external Web service has not stopped, there are cases in which the resources of the device in which the service broker is installed become overwhelmed.

### SUMMARY OF THE INVENTION

The present invention provides a service flow processing apparatus that makes it reduce the load of handling an abnormality that has occurred in a service on a network.

According to one aspect of the present invention, there is provided a service flow processing apparatus comprising: a request unit that requests a service on a network to perform processing, in accordance with a service flow description document and an interface description document; a reception unit that receives a response from the service; a generation unit that generates a proxy service corresponding to the service; and a change unit that, if a normal response has not been received by the reception unit, changes a destination of the request for the service described in the interface description document to the proxy service.

Further features of the present invention will become apparent from the following description of exemplary embodiments with reference to the attached drawings.

### BRIEF DESCRIPTION OF THE DRAWINGS

FIG. 1 is a diagram showing an overview of a Web service flow processing apparatus according to an embodiment.

FIG. 2 is a diagram showing an internal processing configuration of a service flow processing unit for automatically switching external service invocation processing.

FIGS. 3A and 3B are diagrams showing a Web service flow description document and a concrete example thereof.

FIGS. 4A and 4B are diagrams showing a concrete example of an interface description document for external Web service B.

FIG. 5 is a flowchart showing processing performed by an external service monitoring processing unit according to an embodiment.

FIG. 6 is a flowchart showing processing performed by the external service monitoring processing unit according to an embodiment.

FIG. 7 is a diagram showing an exemplary configuration of an information processing apparatus that functions as a flow processing apparatus according to an embodiment.

### DESCRIPTION OF THE EMBODIMENTS

The following describes details of a preferred embodiment of the present invention with reference to the drawings.

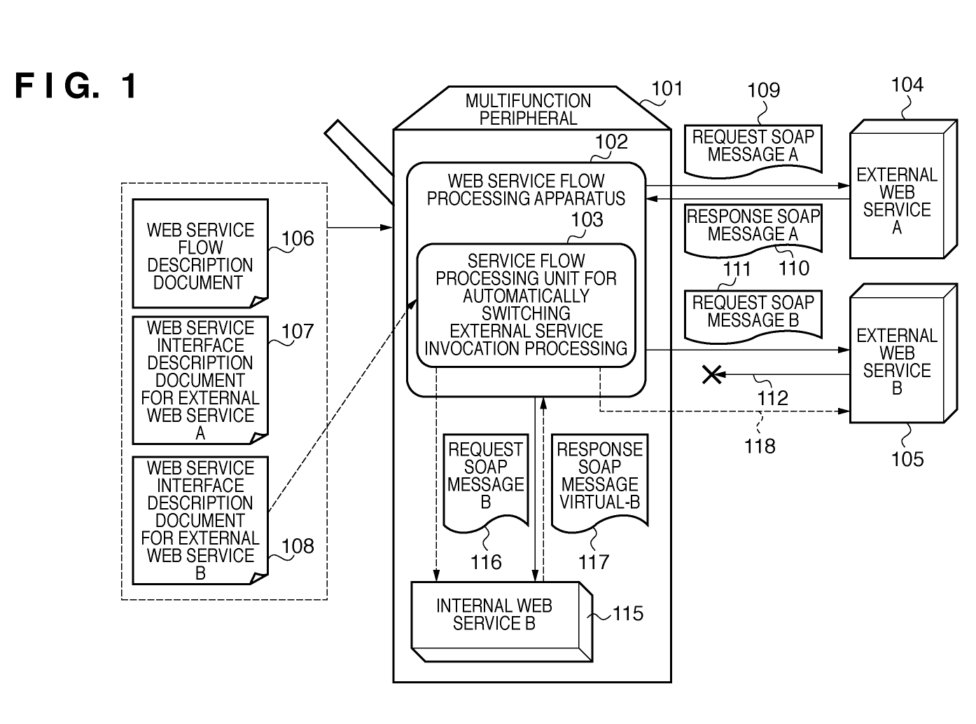

Below is a description of an overview of processing for automatically switching external service invocation processing as Embodiment 1 with reference to FIG. 1. It should be noted that in the following embodiment, external services are handled as Web services.

FIG. 1 is a diagram showing an overview of a Web service flow processing apparatus according to Embodiment 1. In FIG. 1, reference numeral 101 denotes a multifunction peripheral (MFP) having a plurality of functions such as copying, scanning, and printing. In Embodiment 1, the MFP 101 functions as a Web service flow processing apparatus 102 that can read a Web service flow description document and sequentially execute Web services in accordance with the content described therein. The Web service flow processing apparatus 102 includes a service flow processing unit for automatically switching external service invocation processing 103 (hereinafter, called the switching processing unit 103). Although the Web service flow processing apparatus 102 is described as being installed in the MFP 101 in the description of the present embodiment, the present invention is not limited to a Web service flow processing apparatus being installed in an MFP.

Reference numeral 104 denotes an external Web service A that is to be invoked by the Web service flow processing apparatus 102, and reference numeral 105 denotes an external Web service B that is to be invoked by the Web service flow processing apparatus 102.

Reference numeral 106 denotes a Web service flow description document that describes a procedure for sequentially invoking the external Web service A 104 and the external Web service B 105. Reference numeral 107 denotes a Web service interface description document for external Web service A, and reference numeral 108 denotes a Web service interface description document for external Web service B. Details of the configuration of these description documents are described later.

The following describes processing performed by the Web service flow processing apparatus 102 and the switching processing unit 103. First, the Web service flow processing apparatus 102 reads the Web service flow description document 106 and starts flow processing in accordance with the content described therein. The Web service flow processing apparatus 102 then sequentially executes the content described in the Web service flow description document 106 up to description content that relates to invoking the external Web service A 104.

Next, the Web service flow processing apparatus 102 generates a request SOAP message A 109, and transmits the request SOAP message A 109 to the external Web service A 104. The external Web service A 104 performs processing and transmits a response SOAP message A 110, which is a result of the processing, to the Web service flow processing apparatus 102. The Web service flow processing apparatus 102 receives the response SOAP message A 110, extracts necessary data from the message, and generates a request SOAP message B 111. Thereafter, the external Web service B 105 is accessed.

At this time, the external Web service B 105 is considered to have stopped due to the fact that the power supply of a server device in which the service is installed has been cut off. In such a case, the Web service flow processing apparatus 102 determines that an error has occurred due not having received a response 112 from the external Web service B 105. In this way, if an access to an external service results in an error, the Web service flow processing apparatus 102 transmits an error notification to the switching processing unit 103.

Upon receiving the error notification, the switching processing unit 103 obtains the Web service interface description document 108 for the external Web service B 105 in which an error occurred. An end point described in the Web service interface description document 108 indicates the location of a service on a network. The switching processing unit 103 then converts the end point described in the Web service interface description document 108 into an end point that indicates the location of an internal service, which is a virtual service, in the MFP 101.

The pre-conversion end point pertaining to the external Web service B 105 is stored. Thereafter, an internal Web service B 115 is automatically generated from the Web service interface description document 108 in which the end point has been converted. After the internal Web service B 115 has been automatically generated, the Web service flow processing apparatus 102 again executes the flow processing that was being executed when the error occurred. Here, the Web service interface description document 108 is re-read, and the access destination has been updated since the end point has been updated.

In this way, the Web service flow processing apparatus 102 accesses the internal Web service B 115, and transmits a request SOAP message B 116 (the same as the request SOAP message B 111). Thereafter, the internal Web service B 115 automatically generates a response SOAP message virtual-B 117 that can be interpreted by the invoking party, and transmits the response SOAP message virtual-B 117. In other words, the internal Web service B 115 transmits a virtual response SOAP message in place of the external Web service B 105.

As a result, even if an error occurs when the Web service flow processing apparatus 102 accesses an external Web service, the flow processing does not stop, but rather the next flow process described in the Web service flow description document 106 can be executed. Thereafter, the switching processing unit 103 monitors the external Web service B 105 (118).

For example, a stub is automatically generated from the Web service interface description document 108, and the responsiveness of the external Web service B 105 is checked by repeatedly accessing the end point stored by the switching processing unit 103. The switching processing unit 103 monitors the external Web service B 105 by repeating this operation at a constant interval or irregularly until the external Web service B 105 has restarted.

Upon confirming that the external Web service B 105 has restarted due to receiving a response to the access from the external Web service B 105, the switching processing unit 103 reverts the end point in the Web service interface description document 108. As a result, the Web service flow processing apparatus 102 can again communicate with the external Web service B 105.

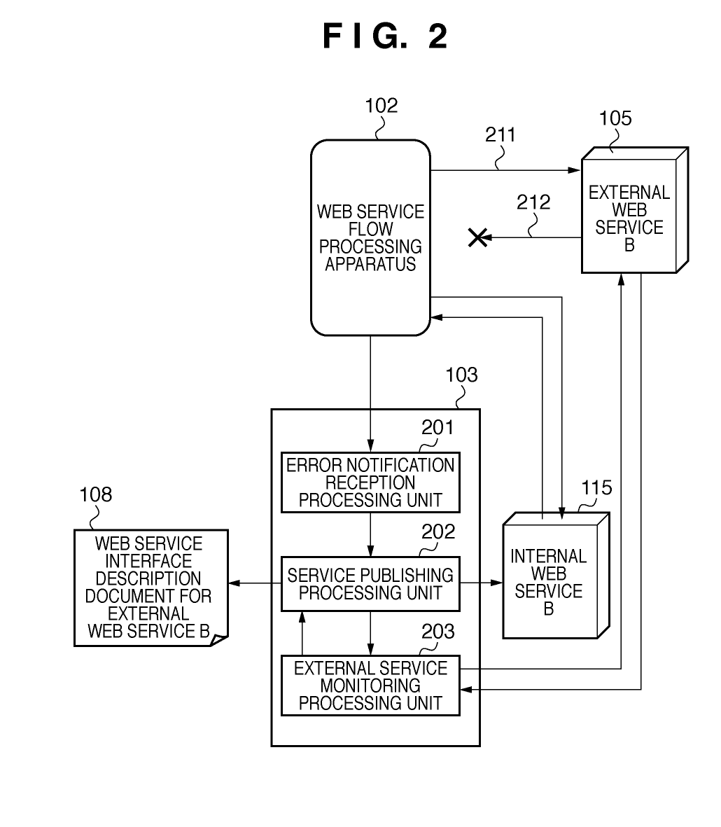

Next, the specific content of processing performed by the switching processing unit (service flow processing unit for automatically switching external service invocation processing) 103 is described with reference to FIG. 2. FIG. 2 is a diagram showing an internal processing configuration of the switching processing unit 103. The switching processing unit 103 is configured from an error notification reception processing unit 201, a service publishing processing unit 202, and an external service monitoring processing unit 203.

When the Web service flow processing apparatus 102 performs an access 211 to the external Web service B 105, a response 212 for the access 211 is not received if the external Web service B 105 has stopped due to a device problem or other cause. In this case, the Web service flow processing apparatus 102 interprets that an error has occurred in the external Web service B 105. The Web service flow processing apparatus 102 then notifies the error notification reception processing unit 201 that an error has occurred, along with information regarding the external Web service B 105 to which access was attempted.

The error notification reception processing unit 201 notifies the service publishing processing unit 202 of the information regarding the external Web service B 105 in which the error occurred. The service publishing processing unit 202 first specifies a location indicated by the end point that is described in the Web service interface description document 108 and that indicates the network location of the external Web service B 105. Next, the service publishing processing unit 202 converts the end point described in the Web service interface description document 108 into an end point that indicates the network location of an internal Web service, and publishes the end point of the internal Web service to the MFP 101. The Web service flow processing apparatus 102 and the switching processing unit 103 are installed in the MFP 101. The pre-conversion end point information (indicating the location of the external Web service B 105) is also stored.

Here, the service publishing processing unit 202 automatically generates the internal Web service B 115 from the Web service interface description document 108 in which the end point has been converted, and publishes the internal Web service B 115 as a service. The service publishing processing unit 202 then passes the Web service interface description document 108 and the stored end point information indicating the external Web service B 105 to the external service monitoring processing unit 203.

As a result, the external service monitoring processing unit 203 starts monitoring the state of the external Web service B 105. After the internal Web service B 115 has been automatically generated, the Web service flow processing apparatus 102 again executes the flow process that was being executed when the error occurred. At this time, the Web service interface description document 108 is re-read, and therefore the access destination indicated by the updated end point is automatically accessed. Accordingly, the internal Web service B 115 can be accessed, and a response can be received therefrom.

In this way, even if an error occurs when the Web service flow processing apparatus 102 accesses the external Web service B 105, flow processing does not stop, but rather the next flow process described in the Web service flow description document 106 can be executed.

While processing with the internal Web service B 115 is being executed, the external service monitoring processing unit 203 continuously monitors the external Web service B 105. The monitoring method is, for example, a method in which a stub is automatically generated from the Web service interface description document 108, and the responsiveness of the external Web service B 105 is checked by repeatedly accessing the end point stored by the service publishing processing unit 202. The external service monitoring processing unit 203 monitors the external Web service B 105 by repeating this operation at a constant interval until the external Web service B 105 has restarted.

Thereafter, upon confirming that the external Web service B 105 has restarted due to receiving a response to the access from the external Web service B 105, the external service monitoring processing unit 203 notifies the service publishing processing unit 202 that the external Web service B 105 has restarted. The service publishing processing unit 202 reverts the end point described in the Web service interface description document 108 to the stored end point that indicates the network location of the external Web service B 105.

Furthermore, the service publishing processing unit 202 stops publishing the internal Web service B 115 and deletes all of the information of the internal Web service B 115. Thereafter, the Web service flow processing apparatus 102 reads the Web service interface description document 108. Accordingly, the external Web service B 105 that has restarted can be accessed, and a normal response can again be received as a result of the access.

The following describes details of the processing performed by the switching processing unit 103 with use of specific data.

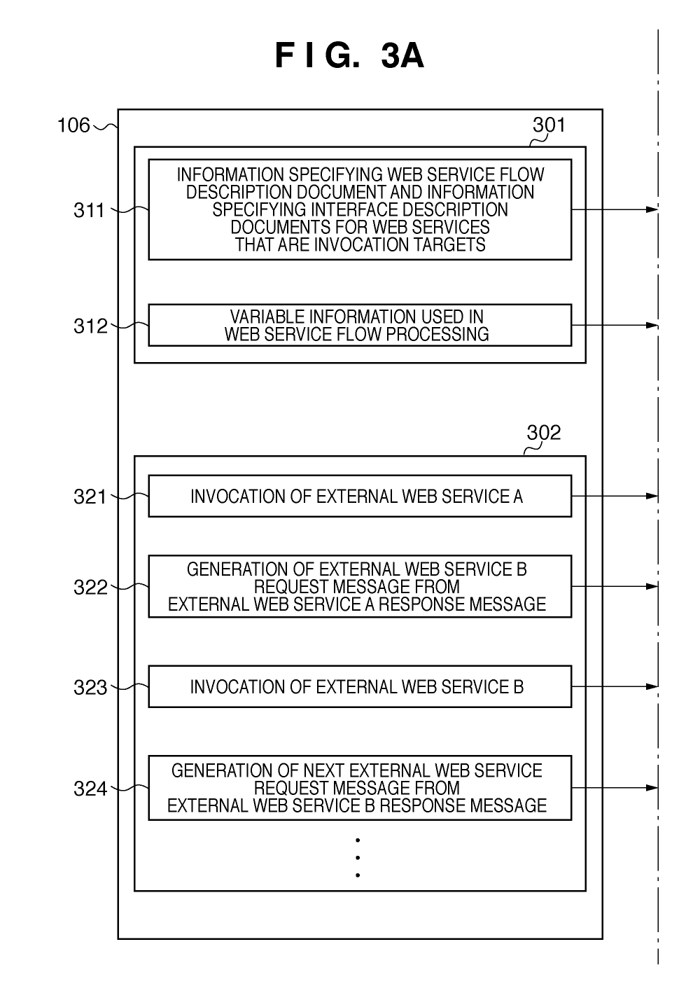

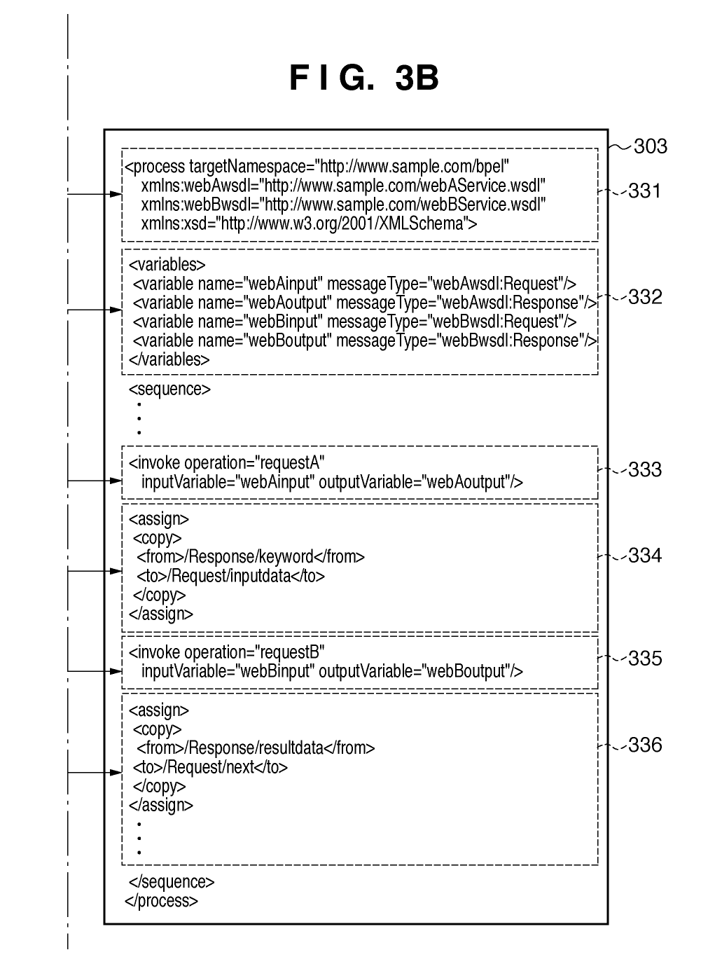

FIGS. 3A and 3B are diagrams showing the Web service flow description document 106 and a concrete example 303 thereof. As shown in FIGS. 3A and 3B, the Web service flow description document 106 is configured from a declaration part 301 that describes variable declarations and the like in terms of a program, and a logic part 302 that describes flow processing logic and the like.

The declaration part 301 describes information 311, which is information specifying the Web service flow description document 106 and information specifying interface description documents for Web services that are invocation targets, and variable information 312 used in Web service flow processing.

Conventionally, the logic part 302 describes all the content of flow processing, such as a description for receiving a request message from a client and a description for transmitting a response message to the client; however, such information has been omitted here.

Information 321 describes the content of processing for invoking the external Web service A, causing the external Web service A to perform processing, and receiving a response message that is the result of such processing. Information 322 describes the content of processing for extracting the processing result from the received response message and generating a request message that can be interpreted by the external Web service B. Information 323 describes the content of processing for invoking the external Web service B, causing the external Web service B to perform processing, and receiving a response message that is the result of such processing. Information 324 describes the content of processing for extracting the processing result from the received response message and generating a request message that can be interpreted by the next external Web service.

Reference numeral 303 denotes a concrete example of the Web service flow description document 106. In this example, the concrete example 303 is described in a language called WS-BPEL, which is a language that is a standard specification for describing a Web service processing flow in an XML document. WS-BPEL is an abbreviation for Web Services Business Process Execution Language. XML is an abbreviation for eXtensible Markup Language. The following is a comparison of the configuration of the Web service flow description document 106 and the Web service flow description document 303.

Information 331 corresponds to the description content of the information 311 and describes information specifying a Web service flow description document, as well as information specifying an interface description document (WSDL document) for the Web service A 104 and the Web service B 105, which are invocation targets. Here, Namespace is described as an attribute value of the <process> tag. Information 332 corresponds to the description content of the variable information 312 and describes <variable> tags, each of which describes type information for message variables used when executing flow processing.

Information 333 corresponds to the description content of the information 321 and includes an <invoke> tag that describes the content of processing for invoking the external Web service A and receiving a response message that is the result of causing processing to be executed. Information 334 corresponds to the description content of the information 322 and describes the content of processing for generating a request message that can be interpreted by the external Web service B, based on an XPath and a processing result extracted from the received response message using the XPath. This processing content is described in an <assign> tag or the like.

Information 335 corresponds to the description content of the information 323 and describes the content of processing for invoking the external Web service B and receiving a response message that is the result of causing processing to be executed. This processing content is described in an <invoke> tag. Information 336 corresponds to the description content of the information 324 and describes the content of processing for generating a request message that can be interpreted by an external Web service that is to be subsequently invoked, based on an XPath and a processing result extracted from the received response message using the XPath. This processing content is described in an <assign> tag or the like.

The <assign> tag, <invoke> tag, and the like that correspond to the description content of the logic part 302 are called “activities” in WS-BPEL. Such tags are abstracted expressions of Web service flow processing, such as the <assign> tag being for message manipulation and conversion, and the <invoke> tag being for invoking an external Web service. In the present embodiment, a case is described in which an error occurs when executing the invoke activity in the information 335.

If the invoke activity in the information 335 is executed and a response to an access to an external service is not received, the flow processing stops at this point since it is impossible to move to the processing of the next activity indicated in the information 336. The present embodiment realizes the prevention of a stop in the middle of such flow processing.

The following describes the content of processing performed by the service publishing processing unit 202 with use of a concrete example of the Web service interface description document 108 that has been described in WSDL.

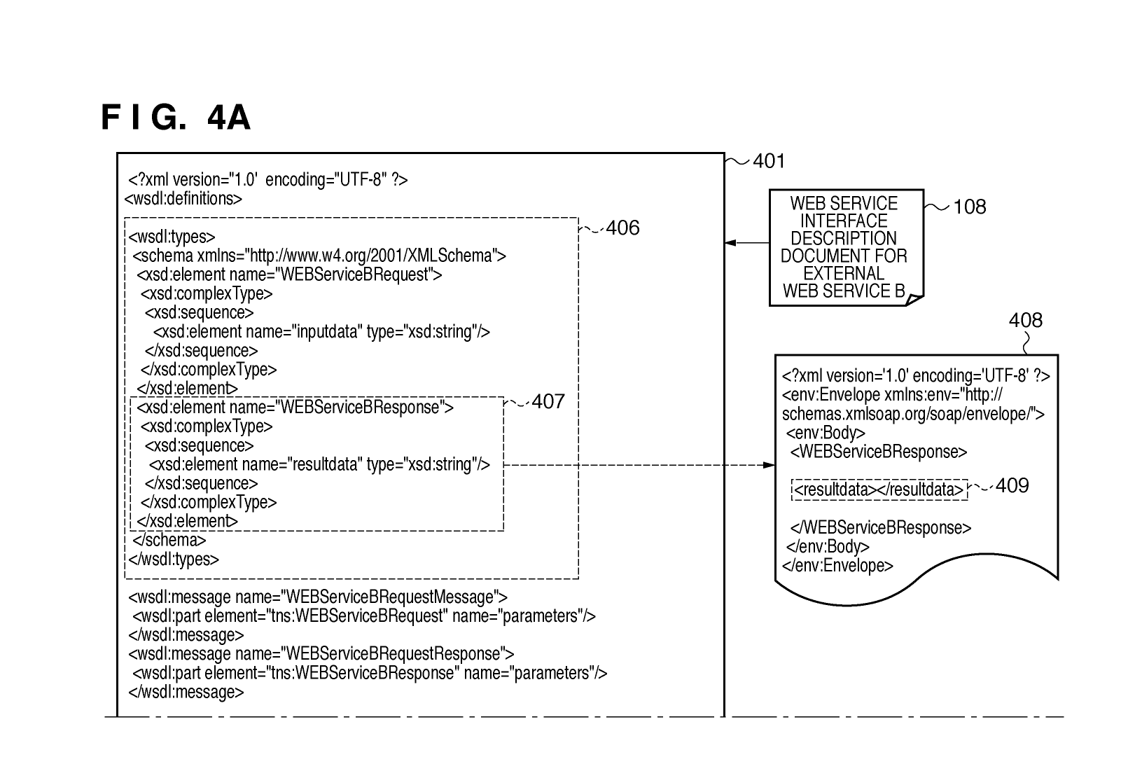

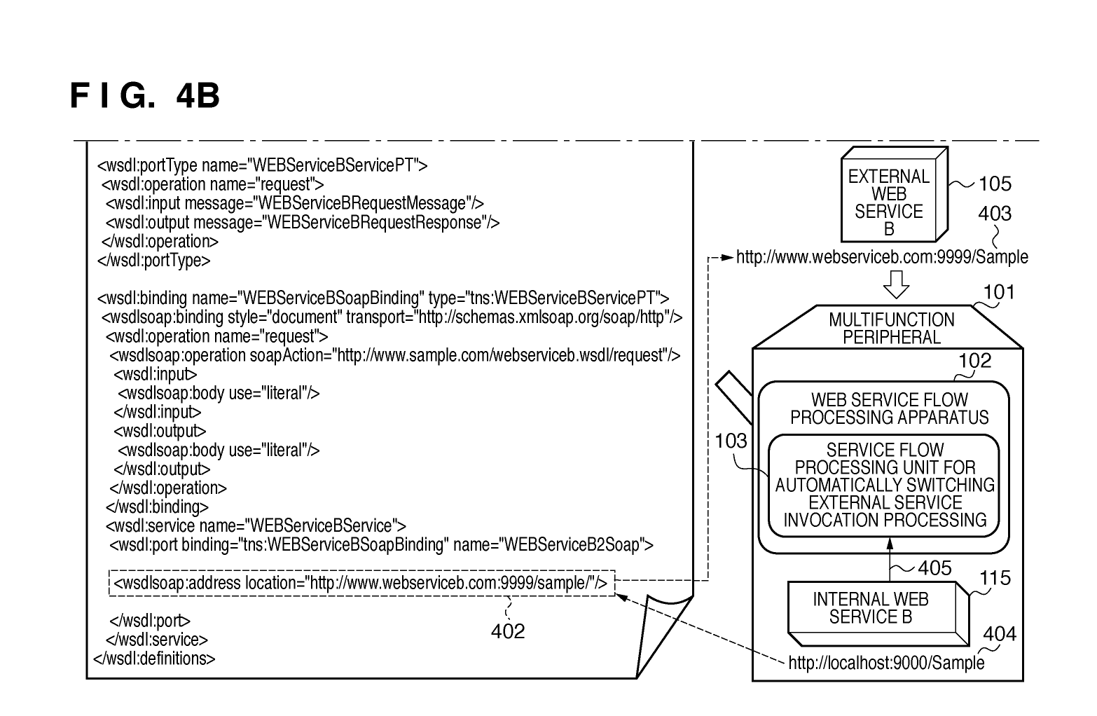

FIGS. 4A and 4B are diagrams showing a concrete example 401 of the Web service interface description document 108 for external Web service B. In information 402, end point information 403 indicating the network location of the external Web service B 105 is described as a WSDL <address> tag. The service publishing processing unit 202 converts this end point information into end point information 404 that indicates the network location of the internal Web service B 115 that is automatically generated. Since the internal Web service B 115 is published within the MFP 101, the end point information 404 indicates the network location of the MFP 101.

Next is a description of a response 405 that the internal Web service B 115 transmits in response to an access from the Web service flow processing apparatus 102. In WSDL 401, the type of message that can be interpreted by the Web service B 105 when a request is made and information regarding the type of message that is transmitted in response to the request are described as an XML Schema 406. The service publishing processing unit 202 automatically generates the internal Web service B 115 so as to be capable of exchanging SOAP messages in the same way as messages are exchanged with the actual Web service B 105.

For this reason, the response 405 from the internal Web service B 115 is a SOAP message. Information 407 describes the type of message to be used when generating a response, and the internal Web service B 115 automatically generates a SOAP message 408 with use of the information 407. Since the internal Web service B 115 does not actually perform processing, a SOAP message is generated so as to, for example, include a <resultdata> tag that does not contain any data, as shown by information 409. Also, it can be interpreted from <xsd:element name=“resultdata” type=“xsd:string”/> in information 407 that the type of information contained in the <resultdata> tag is String information. It is also possible to insert an arbitrary character string and transmit the character string as a response. As described above, the internal Web service B 115 transmits a virtual response SOAP message 408 in place of the external Web service B 105.

As a result, the Web service flow processing apparatus 102 receives the SOAP message 408 as the response 405, and therefore instead of processing stopping at this point, it is possible to execute flow processing after the reception.

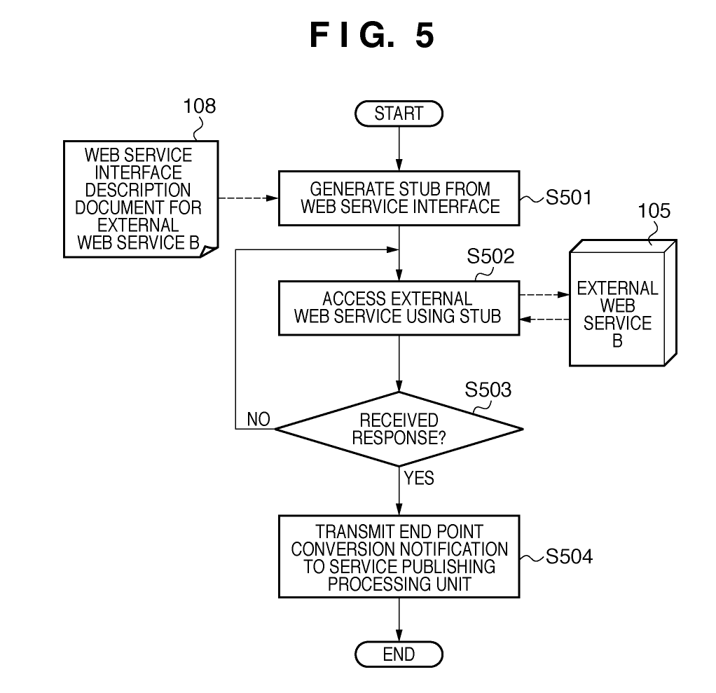

The following describes an example of processing performed by the external service monitoring processing unit 203 with reference to FIG. 5. FIG. 5 is a flowchart showing processing performed by the external service monitoring processing unit 203 according embodiment 1. First, in S501 the Web service interface description document 108 and the end point information indicating the external Web service B 105 are obtained from the service publishing processing unit 202. Then a stub for accessing the external Web service B 105 is generated based on the obtained information.

Next, in S502 the external Web service B 105 is accessed using the stub generated in S501. Then, in S503 a judgment is performed as to whether a response has been received from the external Web service B 105. If a response has not been received, processing returns to S502, and the processing described above is repeated.

On the other hand, as a result of the access performed in S502, if the external Web service B 105 has restarted and a response has been received, the judgment result of S503 is that a response has been received, and processing proceeds to S504. In S504, a notification indicating that the end point description in the Web service interface description document 108 is to be reverted is transmitted to the service publishing processing unit 202.

According to Embodiment 1, even if a Web service flow processing apparatus accesses an external Web service that has stopped due to the occurrence of a fault, processing continues instead of stopping at this point. Also, it is not necessary for a service flow description document to describe complex avoidance processing to be performed in the case of an error, thereby reducing the time and effort required of the person creating the service flow description document, and lowering human cost.

The following describes details of Embodiment 2 of the present invention with reference to the drawings. Similarly to Embodiment 1, external services are handled as Web services in Embodiment 2.

In Embodiment 1, the external service monitoring processing unit 203 monitors whether a response to the access to the external Web service B 105 has been received. Embodiment 2 describes processing performed in the case in which a judgment reference for ending monitoring is provided from the outside, and monitoring is ended based on the judgment reference.

It should be noted that the configurations of the MFP 101, the Web service flow processing apparatus 102, and the switching processing unit 103 are the same as the corresponding configurations described in Embodiment 1 and shown in FIGS. 1 and 2, and therefore descriptions thereof have been omitted.

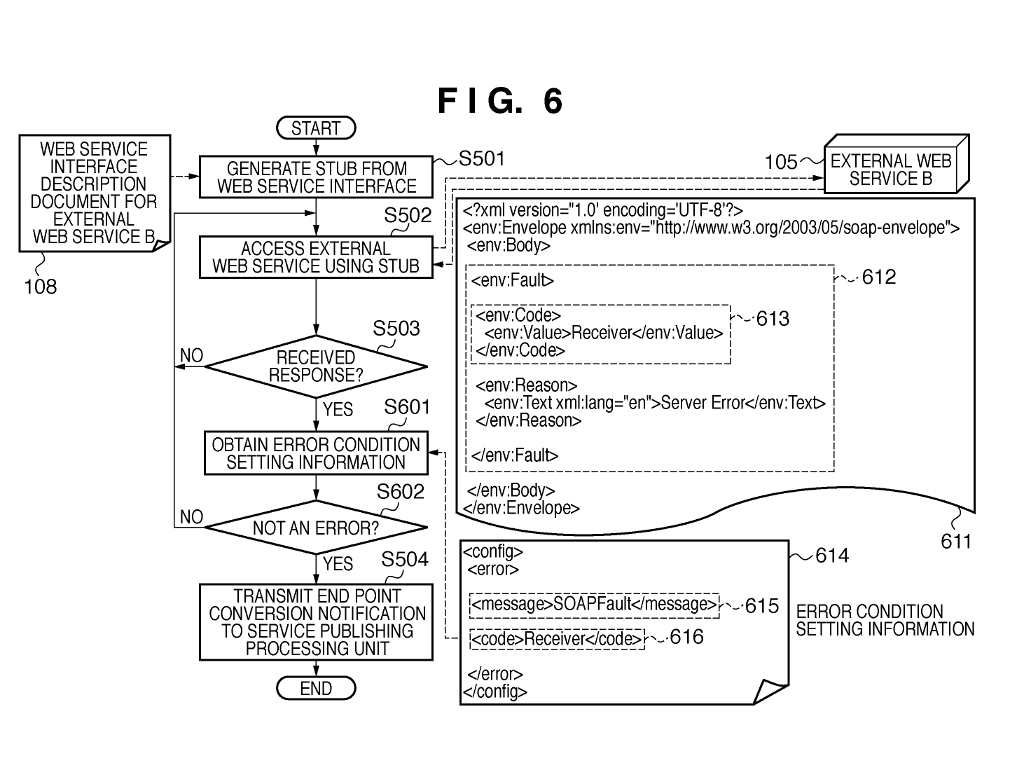

FIG. 6 is a flowchart showing processing performed by an external service monitoring processing unit 203 according to Embodiment 2. Similarly to Embodiment 1, in S502 a SOAP message 611 shown in FIG. 6 is received from the external Web service B 105 as a result of accessing the external Web service B 105. The SOAP message 611 includes an <env:Fault> tag 612 in an <env:Body> tag.

In other words, the SOAP message 611 is a SOAP Fault. A SOAP Fault is a SOAP message that is transmitted to an accessing party if the accessing party accesses a Web service and the Web service receives a request, but an error occurs in the processing performed in the Web service.

In the SOAP Fault, an <env:Code> tag 613 indicates whether the cause of the error is a problem on the requesting party side or a problem on the Web service side. In this example, the value of the <env:Value> tag is “Receiver”, which indicates that the problem is on the Web service B 105 side. If the value of the <env:Value> tag is “Sender”, the problem is on the requesting party side (the Web service flow processing apparatus 102).

Examples of a problem on the requesting party side include the case in which the request SOAP message generated by the requesting party does not conform to specifications. In this way, if the SOAP message 611 has been received, in the processing of S503 for judging whether a response has been received, it is judged that a response has been received.

Also, in FIG. 6, reference numeral 614 denotes an example of error condition setting information (e.g., described in XML format) that has been set in the MFP 101, the value “SOAPFault” is described as the value of a <message> tag 615, and the value “Receiver” is described as the value of a <code> tag 616.

In S601, the error condition setting information 614 is read, and an error judgment is determined to be performed if the SOAP message is a SOAP Fault, and furthermore the cause of the fault is on the Web service (Receiver) side. For this reason, in S602 error judgment processing is performed, and based on the SOAP message 611 and the error condition setting information 614, it is still judged that for the SOAP message 611 an error has occurred. As a result, processing returns to S502, and the processing described above is repeated.

According to Embodiment 2, error condition setting information from the outside is provided in the external service monitoring processing performed in Embodiment 1, thereby enabling controlling whether to continue the monitoring even if a response has been received from an external service.

The following describes details of Embodiment 3 of the present invention with reference to the drawings. Embodiments 1 and 2 describe examples in which the service flow processing unit for automatically switching external service invocation processing is installed in a device, specifically an MFP. However, the present invention is not limited to this, and application to an information processing apparatus (computer) is also possible.

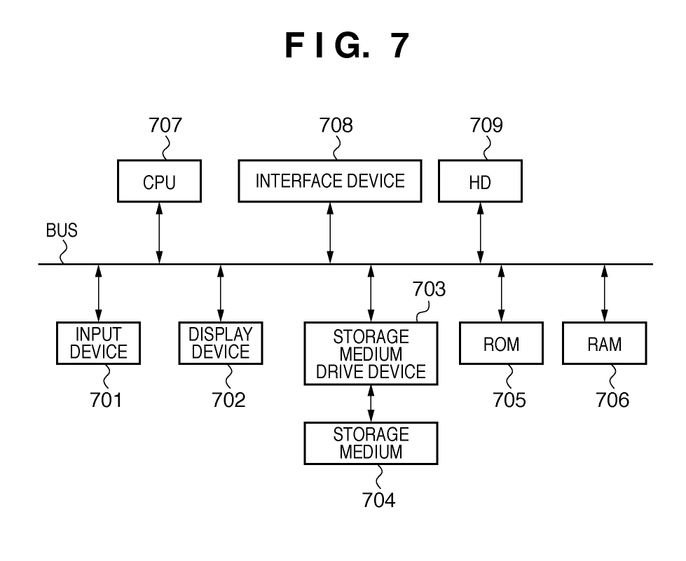

FIG. 7 is a diagram showing an exemplary configuration of an information processing apparatus that functions as a flow processing apparatus according to Embodiment 3. Specifically, FIG. 7 shows an exemplary hardware configuration of an information processing apparatus that executes software that realizes the functionality of the embodiments described above.

In terms of hardware configuration, the information processing apparatus includes an input device 701, a display device 702, a storage medium drive device 703, a ROM 705, a RAM 706, a CPU or MPU 707, an interface device 708, and an HD (Hard Disk) 709. The input device 701 is configured from a keyboard, a mouse, or the like that an operator of the information processing apparatus operates, and is used for inputting various types of operation information and the like to the information processing apparatus. The display device 702 is configured from a display or the like that the operator of the information processing apparatus uses, and is used for displaying various types of information (or screens) and the like.

The interface device 708 is an interface that connects the information processing apparatus to a network or the like. A program, a Web service flow description document, and the like that pertain to the above-described processing and the like are provided to the information processing apparatus by, for example, a storage medium 704 such as a CD-ROM, or by being downloaded via a network or the like. The storage medium 704 is set in the storage medium drive device 703, and the program is installed from the storage medium 704 to the HD 709 via the storage medium drive apparatus 703.

The ROM 705 stores, for example, a program that is read first when power is introduced to the information processing apparatus. The RAM 706 is a main memory of the information processing apparatus. The CPU 707 realizes the processing content described above by reading the program from the HD 709, storing the program in the RAM 706, and executing the program. Besides the program, the HD 709 can store a Web service flow description document, a Web service interface description document, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-171233, filed Jun. 30, 2008, which is hereby incorporated by reference herein in its entirety.

What is claimed is:

1. A service flow processing apparatus comprising:
a request unit that requests a service on a network to perform processing, in accordance with a service flow description document and an interface description document;
a reception unit that receives a response from the service;
a generation unit that generates a proxy service corresponding to the service; and
a change unit that, if a normal response has not been received by the reception unit, changes a destination of the request for the service described in the interface description document to the proxy service.

2. The service flow processing apparatus of claim 1,
wherein the request unit requests the proxy service to perform processing, in accordance with the interface description document in which the destination has been changed.

3. The service flow processing apparatus of claim 1,
wherein if a normal response has not been received by the reception unit during a first process of a service flow described in the service flow description document, the request unit executes a second process of the service flow described in the service flow description document, and in the second process, requests the proxy service to perform processing, in accordance with the interface description document in which the destination has been changed.

4. The service flow processing apparatus of claim 1,
wherein the generation unit generates a proxy service for the service corresponding to the interface description document of the service.

5. The service flow processing apparatus of claim 1,
wherein the generation unit generates the proxy service within the service flow processing apparatus.

6. The service flow processing apparatus of claim 1,
wherein if the reception unit has received a predetermined response from the service on the network, the change unit reverts the destination of the request for the service described in the interface description document of the service to the service on the network.

7. The service flow processing apparatus of claim 6,
wherein if the destination of the request for the service has been reverted to the service on the network, the request unit executes a process of a service flow described in the service flow description document, and in the process of the service flow, requests the service on the network to perform processing, in accordance with the interface description document in which the destination has been reverted to the service on the network.

8. A service flow processing method executed by a service flow processing apparatus, comprising:
requesting a service on a network to perform processing, in accordance with a service flow description document and an interface description document;
receiving a response from the service;
generating a proxy service corresponding to the service; and
changing, if a normal response has not been received in the receiving step, a destination of the request for the service described in the interface description document to the proxy service.

9. The service flow processing method of claim 8, further comprising requesting the proxy service to perform processing, in accordance with the interface description document in which the destination has been changed.

10. The service flow processing method of claim 8, further comprising reverting, if a predetermined response has been received from the service on the network, the destination of the request for the service described in the interface description document of the service to the service on the network.

11. A storage medium having stored therein a computer program for causing a computer to execute a service flow processing method, the service flow processing method comprising:
requesting a service on a network to perform processing, in accordance with a service flow description document and an interface description document;
receiving a response from the service;
generating a proxy service corresponding to the service; and
changing, if a normal response has not been received in the receiving step, a destination of the request for the service described in the interface description document to the proxy service.

12. The storage medium of claim 11,
wherein the service flow processing method further comprises requesting the proxy service to perform processing, in accordance with the interface description document in which the destination has been changed.

13. The storage medium of claim 11,
wherein the service flow processing method further comprises reverting, if a predetermined response has been received from the service on the network, the destination of the request for the service described in the interface description document of the service to the service on the network.
